(19) United States
(12) Patent Application Publication
(10) Pub. No.: US 2024/0037621 A1
(43) Pub. Date: Feb. 1, 2024

(54) VEHICLE DESIGN SYSTEM

(71) Applicant: TOYOTA JIDOSHA KABUSHIKI KAISHA, Toyota-shi (JP)

(72) Inventors: Junya OGAWA, Okazaki-shi (JP); Mai KATO, Miyoshi-shi (JP); Asuka KUROKAWA, Nagoya-shi (JP); Eisaku OKADA, Okazaki-shi (JP)

(73) Assignee: TOYOTA JIDOSHA KABUSHIKI KAISHA, Toyota-shi (JP)

(21) Appl. No.: 18/224,976

(22) Filed: Jul. 21, 2023

(30) Foreign Application Priority Data
Aug. 1, 2022 (JP) 2022-122761

(51) Int. Cl. G06Q 30/0601

(52) U.S. Cl. CPC G06Q 30/0621; G06Q 30/0282

(57) ABSTRACT

A vehicle design system allowing a user to obtain a favorite design for the coating of a vehicle. The vehicle design system that presents a design for the coating of a vehicle to a user includes a processing device including: a design registration unit having registered therein a plurality of pieces of design information on the vehicle; a designer registration unit having registered therein designer information for each of a plurality of designers creating a design of the vehicle; a design output unit that outputs to a display device registered design information; a design selection determination unit that determines whether the design information output to the display device has been selected by an input from an input device; and a designer output unit that, if it is determined that the design information has not been selected, outputs designer information registered in the designer registration unit to the display device.

### CROSS REFERENCE TO RELATED APPLICATIONS

The present application claims priority from Japanese patent application JP 2022-122761 filed on Aug. 1, 2022, the entire content of which is hereby incorporated by reference into this application.

### BACKGROUND

### Technical Field

The present disclosure relates to a vehicle design system.

### Background Art

Conventionally, computer systems that optimize a vehicle specification to meet the needs of customers have been developed (see, for example, JP 2003-242329 A). Such a computer system analyzes the factors associated with the needs of customers for the vehicle to determine whether the vehicle meets the needs of customers. Here, the computer system extracts the needs of customers from the customer database if it is determined that the vehicle does not meet the needs of customers and determines a vehicle specification optimized to meet the extracted needs of customers.

### SUMMARY

Unfortunately, while the above-stated system, when applied to a coating design of a vehicle, can present a plurality of pieces of design information registered in advance in a. computer, design information that the system can present is limited, and thus designs from which a user can select are limited in number. Meanwhile, a user trying to create such a design may find it difficult to create a design for the entire vehicle. Consequently, it may be difficult for the user to obtain a favorite design.

The present disclosure has been made in view of the foregoing and provides a vehicle design system that allows a user to obtain a favorite design for the coating of a vehicle.

In view of the foregoing, the present disclosure is a vehicle design system that presents a coating design of a vehicle to a user, including a processing device. The processing device includes: a design registration unit configured to have registered therein a. plurality of pieces of design information on the vehicle; a designer registration unit configured to have registered therein designer information for each of a plurality of designers creating a design of the vehicle; a design output unit configured to output design information registered in the design registration unit to a display device; a design selection determination unit configured to determine whether the design information output to the display device has been selected by an input from an input device; and a designer output unit configured to, if it is determined that the design information output to the display device has not been selected, output designer information registered in the designer registration unit to the display device.

According to the present disclosure, the user can select, via the input device, the design information displayed on the display device by the design output unit. Here, if the user has not selected the design information displayed on the display device, the design selection determination unit determines that the user has not selected the design information displayed on the display device, and designer information registered by the designer output unit is displayed on the display device, This allows the user to submit a request to create design to a designer creating favorite designs based on the designer information.

In some embodiments, in the design registration unit, a plurality of pieces of design information may be associated with and registered for each of a plurality of pieces of preference information. The processing device may include a preference selection unit configured to select one piece of preference information from the plurality of pieces of preference information by an input from the input device. The design output unit may output design information associated with the selected piece of preference information to the display device.

According to this embodiment, when the user enters a preference for a favorite design (design preference) via the input device, the preference selection unit selects one piece of preference information from the plurality of pieces of preference information. Then, design information associated with the selected preference information is output from the design output unit to the display device. Consequently, the user can easily select a favorite design that matches the preference from the plurality of pieces of design information registered.

In some embodiments, in the designer registration unit, a plurality of pieces of designer information may be associated with and registered for each of a plurality of pieces of preference information. The processing device may include a preference selection unit configured to select one piece of preference information from the plurality of pieces of preference information by an input from the input device. The designer output unit may output designer information associated with the selected piece of preference information to the display device.

According to this embodiment, when the user enters a preference for a favorite design (design preference) via the input device, the preference selection unit selects one piece of preference information from the plurality of pieces of preference information, Then, designer information associated with the selected preference information is output from the designer output unit to the display device. Consequently, the user can easily select a designer creating favorite designs that match the preference from the plurality of pieces of designer information registered and then submit a request to create a design to the selected designer.

In some embodiments, the vehicle design system may further include: a designer selection determination unit configured to determine whether the designer information output to the display device has been selected by an input from the input device; and a design collection unit configured to transmit design collection information to an outside if it is determined that the designer information output to the display device has not been selected.

Here, if the user has not selected the designer information displayed on the display device, the designer selection determination unit determines that the user has not selected the designer information displayed on the display device, and the design collection unit can transmit design collection information to the outside. In particular, the design collection unit can collect designs that fit the desired preference from the outside by associating the piece of preference information selected by the preference selection unit with the design collection information.

In some embodiments, the designer information may include design information created by the designer.

According to this embodiment, including design information created by the designer in the designer information allows the user to grasp what designs the designer has created so far, from the designer information displayed on the display device. The user can then select a designer and submit a request to create a design to the selected designer.

In some embodiments, the processing device may further include an evaluation registration unit configured to have registered therein designer evaluation information for the designer by an input from the input device.

According to this embodiment, the user can select the designer information displayed on the display device with reference to the evaluation information for the designer registered in the evaluation registration unit.

In some embodiments, the designer evaluation information may include design evaluation information for a design created by the designer, and the designer output unit may associate the design information created by the designer and the design evaluation information corresponding thereto with identification information on the designer as the designer evaluation information, and output the designer evaluation information to the display device.

According to this embodiment, since the design information created by the designer and the design evaluation information corresponding thereto are associated with identification information on the designer and displayed on the display device, the user can submit a request to create a design to a designer that fits the preference of the user.

According to the present disclosure, a user can obtain a favorite design for the coating of a vehicle.

### BRIEF DESCRIPTION OF THE DRAWINGS

FIG. 1 is a schematic diagram for explaining a vehicle design system according to an embodiment of the present disclosure;

FIG. 2 is a block diagram of a processing device of FIG. 1;

FIG. 3 is a diagram for explaining a preference selection unit of FIG. 2, showing a display screen of a display device;

FIG. 4 is a diagram for explaining a design output unit and a design selection determination unit of FIG. 2, showing a display screen of a display device;

FIG. 5 is a diagram for explaining a designer output unit and a designer selection determination unit of FIG. 2, showing a display screen of a display device;

FIG. 6 is a diagram for explaining an evaluation registration unit of FIG. 2, showing a display screen of a display device; and

FIG. 7 is a flowchart of the operation using the vehicle design system of FIG. 1.

### DETAILED DESCRIPTION

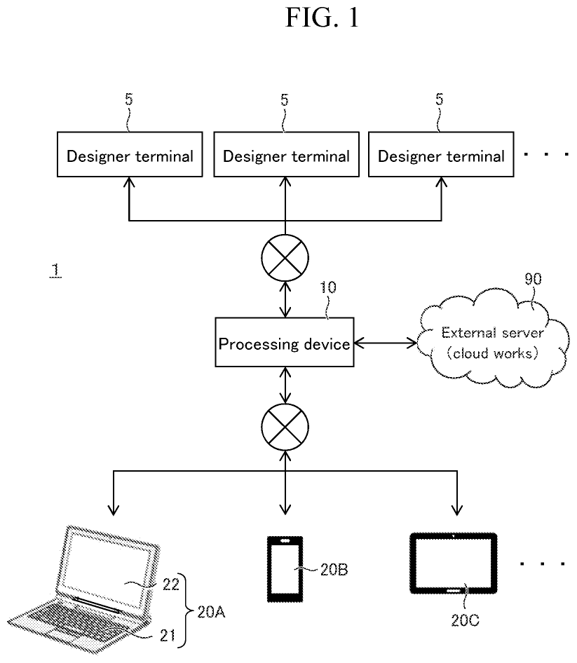

Hereinafter, a vehicle design system according to an embodiment of the present disclosure will be described with reference to FIG. 1 to FIG. 7.

FIG. 1 is a schematic diagram for explaining a vehicle design system according to an embodiment of the present disclosure. As shown in FIG. 1, the vehicle design system 1 according to the present embodiment is a system that presents a coating design of a vehicle to a user. Recently, when applying a coating onto a vehicle, a removable coating may have been applied to the exterior components of the outer shell of the vehicle. The vehicle design system 1 presents information including what coating design is available to the user before applying such a coating onto the vehicle.

The vehicle design system 1 includes a processing device 10 made up of a computing device (not illustrated) including a CPU and the like and a storage device (not illustrated) such as a RAM. The vehicle design system 1 includes user terminals 20A, 20B, and a plurality of designer terminals 5, which are connected to the processing device 10 via the Internet or the like. The processing device 10 is connected to an external server 90 or the like via the Internet or the like.

The user terminals 20A, 20B, 20C may be placed at a car dealership, for example, or may be possessed by individuals who want a coating, For example, the user terminal 20A may include an input device 21 such as a keyboard, and a display device 22 such as a display.

In addition, the user terminal 20B may be a touchscreen type mobile terminal, and the user terminal 20C may be a touchscreen type tablet. The user terminal may be an integrated terminal of a display device and an input device. The designer terminals 5 may have the same configuration as that of one of the above-stated user terminals.

The following describes the use of the user terminal 20A including the input device 21 and the display device 22. The display device 22 herein is used to display design information or the like output from the processing device 10 and designer information or the like output from a designer output unit 16, which will be described later, The input device 21 is a device with which the user viewing the display device 22 selects design information or designer information and inputs the selected design information or designer information to the processing device 10.

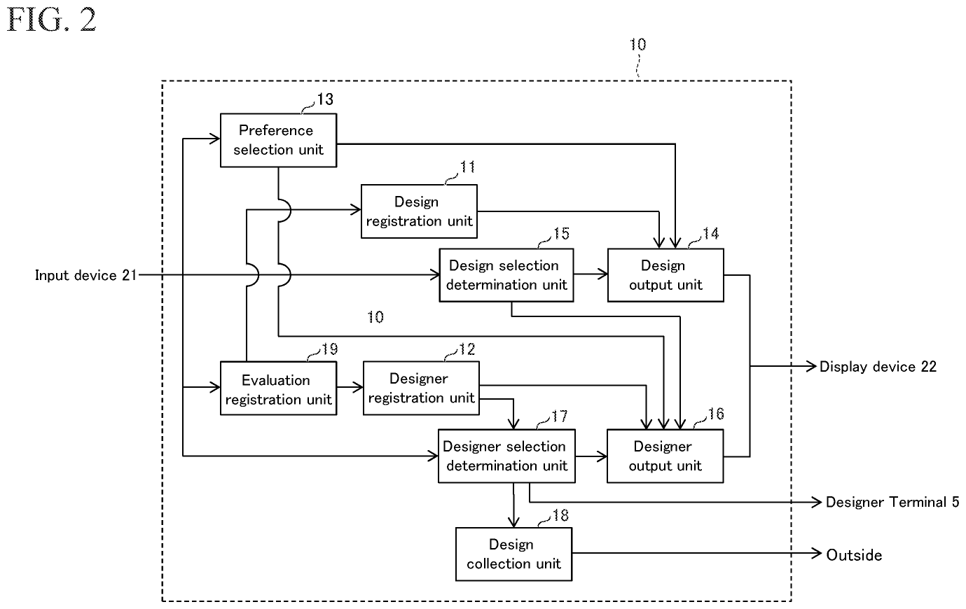

The processing device 10 includes as hardware a storage device (not illustrated) that stores design information, designer information, a program that the processing device 10 executes, and the like, and a computing device (not illustrated) that performs processing, which will be described later. Referring to FIG. 2, the following describes software of the processing device 10, FIG. 2 is a block diagram of the processing device 10 of FIG. 1.

As shown in FIG. 2, the processing device 10 includes as software a design registration unit 11, a designer registration unit 12, a preference selection unit 13, a design output unit 14, a design selection determination unit 15, a designer output unit 16, a designer selection determination unit 17, a design collection unit 18, and an evaluation registration unit 19.

in the design registration unit 11, a plurality of pieces of design information on a vehicle is registered. More specifically, in the present embodiment, in the design registration unit 11, the plurality of pieces of design information is associated with and registered for each of a plurality of pieces of preference information.

Here, the preference information means information about design preferences for a coating design of a vehicle. For example, the preference information is the information classified into preferences of “pretty, romantic, clear, casual, natural, elegant, cool/casual, dynamic, gorgeous, classic, chic, dandy, wild, formal, modern.” Thus, vehicle design information that matches such preference information is registered. However, as long as preferences can make a classification of designs, the information need not be classified into these preferences.

In the designer registration unit 12, designer information for each of a plurality of designers creating vehicle designs is registered. The designer information includes design information created by a designer. In the present embodiment, in the designer registration unit 12, a plurality of pieces of designer information is associated with and registered for each of the plurality of pieces of preference information. The preference information is exemplified by the above-stated preferences. Specifically, the information about the designer who is good at creating designs that fit each preference is registered,

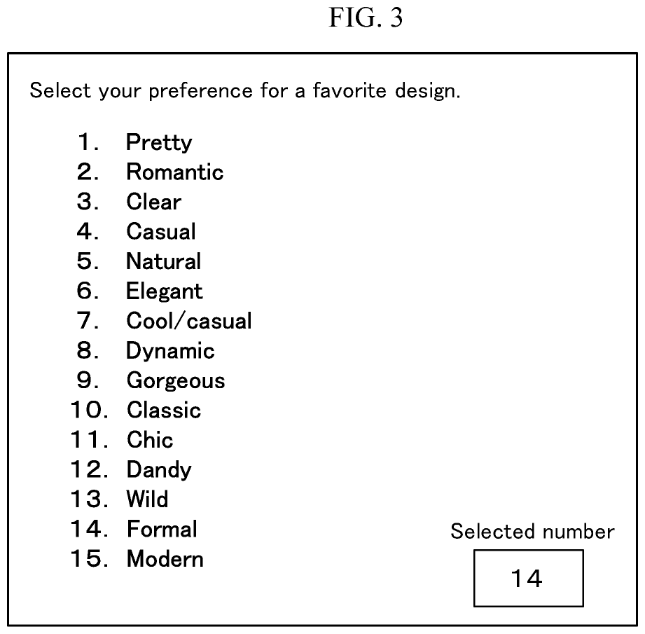

The preference selection unit 13 selects one piece of preference information from the plurality of pieces of preference information by the input from the input device 21. FIG. 3 is a diagram for explaining the preference selection unit 13 of FIG. 2, showing a display screen of the display device 22. Specifically, as shown in FIG. 3, “1, Pretty, 2. Romantic, 3. Clear, 4. Casual, 5. Natural, 6. Elegant, 7. Cool/casual, 8. Dynamic, 9. Gorgeous, 10. Classic, 11. Chic, 12. Dandy, 13. Wild, 14. Formal, 15. Modern” are displayed on the display screen of the display device 22.

The user enters one of the numbers 1 to 15 using the input device 21, whereby the preference selection unit 13 selects one piece of preference information from the plurality of pieces of preference information shown by the numbers 1 to 15. In FIG. 3, while viewing the display screen of the display device 22, the user enters “14” using the input device 21, and then the preference selection unit 13 selects the “formal” code for the preference information.

The design output unit 14 outputs design information registered in the design registration unit 11 to the display device 22. The design output unit 14 outputs the design information associated with the selected piece of preference information. The design selection determination unit 15 determines whether the user has selected the design information output to the display device 22 by the input from the input device 21.

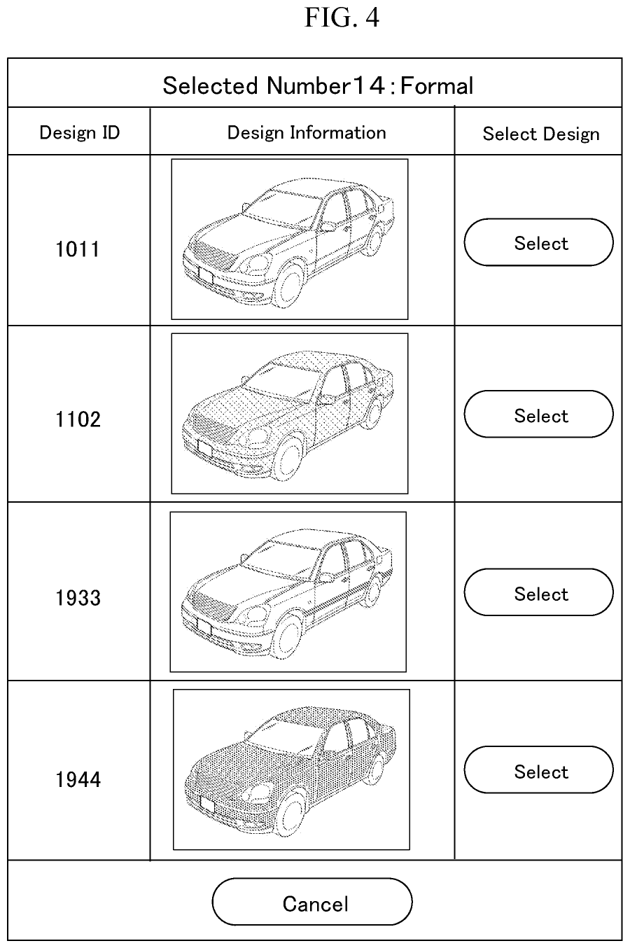

FIG. 4 is a diagram for explaining the design output unit 14 and the design selection determination unit 15 of FIG. 2, showing a display screen of the display device 22. Specifically, as shown in FIG. 4, the design output unit 14 outputs to the display device 22 design information according to the preference information selected in the preference selection unit 13 from the design information registered in the design registration unit 11. For example, when “14,” formal, is selected in the preference selection unit 13 for the preference information, a design ID and design information associated with the selected preference information are displayed.

Here, as shown in FIG. 4, when the “Select” button in the row corresponding to the design ID and design information is clicked by the user input from the input device 21, the design selection determination unit 15 determines that the user has selected the design information output to the display device 22. In this case, the design output unit 14 outputs details of this design information to the display screen and outputs information about an estimate and the like of the coating related to this design information.

In this way, when the user enters a preference for a favorite design (design preference) via the input device 21, the preference selection unit 13 selects one piece of preference information from the plurality of pieces of preference information. Then, design information associated with the selected preference information is output from the design output unit 14 to the display device 22. Consequently, the user can easily select a favorite design that matches the preference from the plurality of pieces of design information registered.

If the design selection determination unit 15 determines that the user has not selected the design information output to the display device 22, the designer output unit 16 outputs designer information registered in the designer registration unit 12 to the display device 22. In the present embodiment, the designer output unit 16 outputs the designer information associated with the selected piece of preference information to the display device 22.

Specifically, when the user does not click any “Select” buttons to select a design of the registered design information on the display screen shown in FIG. 4, a “Cancel” button is clicked. Consequently, the design selection determination unit 15 determines that the user has not selected the design information output to the display device 22 by the input from the input device 21.

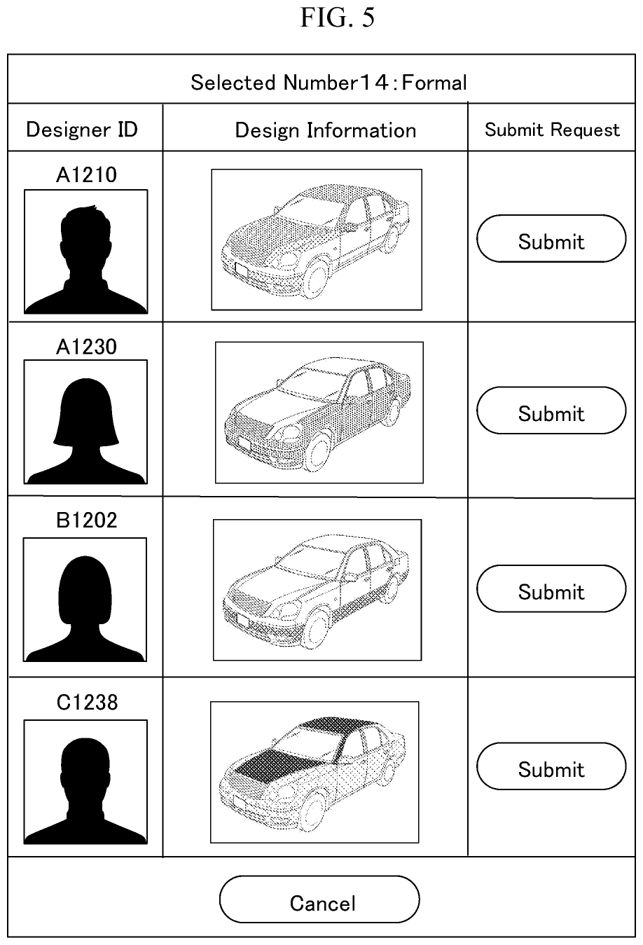

In this case, the designer output unit 16 outputs to the display device 22 designer information associated with “14. Formal” that is the selected piece of preference information. Then, the display screen of the display device 22 changes from the display screen of FIG. 4 to the display screen shown in FIG. 5.

The designer selection determination unit 17 determines whether the user has selected the designer information output to the display device 22 by the input from the input device 21. FIG. 5 is a diagram for explaining the designer output unit 16 and the designer selection determination unit 17 of FIG. 2, showing a display screen of the display device 22.

Specifically, as shown in FIG. 5, the designer output unit 16 outputs to the display device 22 designer information according to the preference information selected in the preference selection unit 13 from the designer information registered in the designer registration unit 12. For example, when “14,” formal, is selected in the preference selection unit 13 for the preference information, designer information including a designer ID associated with the selected preference information or the like is displayed. The designer information also includes a photograph of the designer and design information created by the designer.

The design information displayed here may be design information about a vehicle of the same model, or may be design information about a vehicle of a different model. Since the user can find much more information about the trend of the design information created by the designer, the user can narrow the plurality of designers and select, from the plurality of designers, a designer that creates designs that better match the preference of the user.

Here, as shown in FIG. 5, when the “Submit” button in the row corresponding to the designer ID and design information is clicked by the user input from the input device 21, the designer selection determination unit 17 determines that the user has selected the designer information output to the display device 22. In this case, the designer output unit 16 outputs details of this designer information to the display screen and submits a request to create a design of the vehicle (i.e., sends a request email) to the designer terminal 5 that the selected designer possesses. It should be noted that at this time, the request email sent to the designer terminal 5 may contain, for example, the preference information and the needs of the user.

In this way, when the user enters a preference for a favorite design (design preference) via the input device 21, the preference selection unit 13 selects one piece of preference information from the plurality of pieces of preference information. Then, designer information associated with the selected preference information is output from the designer output unit 16 to the display device 22. Consequently, the user can easily select a designer creating favorite designs that match the preference from the plurality of pieces of designer information registered and then submit a request to create a coating design of a vehicle to the selected designer.

When the user does not click any “Submit” buttons for the registered designer information on the display screen shown in FIG. 5, a “Cancel” button is clicked. Consequently, the designer selection determination unit 17 determines that the user has not selected the designer information output to the display device 22 by the input from the input device 21.

If the designer selection determination unit 17 determines that the user has not selected the designer information output to the display device 22, the design collection unit 18 transmits design collection information to the outside (external server 90). At this time, the design collection unit 18 may add the preference information, the design information associated with the preference information, the needs of the user, and the like to the collection information transmitted to the external server 90. In this way, other designers haying accessed to the external server 90 can grasp information that matches the preference and needs of the user to create vehicle designs.

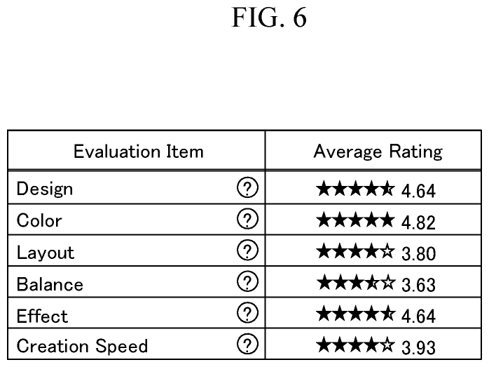

In the evaluation registration unit 19, designer evaluation information for designers is registered by the input from the input device 21. FIG. 6 is a diagram for explaining the evaluation registration unit 19 of FIG. 2, showing a display screen of the display device 22. As shown in FIG. 6, the designer evaluation information contains design evaluation information for a design created by each designer.

Specifically, the design evaluation information represents evaluation of the design with a rating scale of 5 with respect to evaluation items, such as design (whether a goal is expressed), color, layout, balance, effect, and speed (speed of creation of a draft design). However, the evaluation items and the evaluation method are not limited thereto. It should be noted that designer evaluation may be given by an average rating of these evaluation items of the evaluation information.

As stated above, the designer evaluation information registered in the evaluation registration unit 19 may be displayed on the display screen shown in FIG. 5. Specifically, as the designer evaluation information, the designer output unit 16 associates the design information created by the designer and the design evaluation information corresponding thereto with a designer ID (designer identification information) and outputs the designer evaluation information to the display device 22.

In this way, the user can select the designer information displayed on the display device 22 with reference to the evaluation information registered in the evaluation registration unit 19. Furthermore, since the design information created by the designer and the design evaluation information corresponding thereto are associated with identification information on the designer and displayed on the display device 22, the user can submit a request to create a design to a designer that fits the preference of the user. It should be noted that also for other designers who have accessed to the external server 90 and created designs, the evaluation information may be registered in the evaluation registration unit 19 in the same manner.

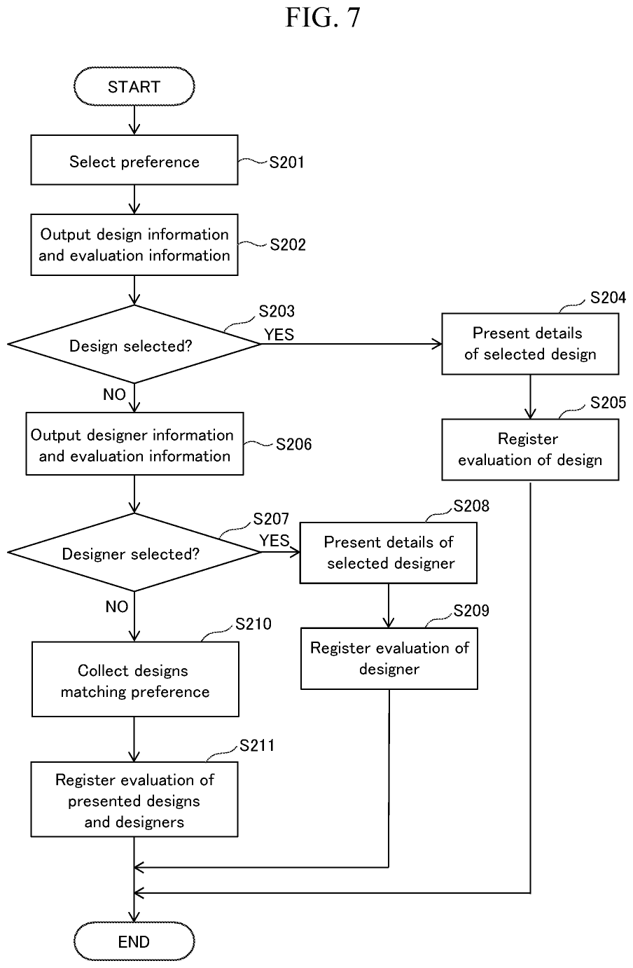

Hereinafter, a flow of the operation using the vehicle design system 1 will be described referring to FIG. 7.

First, in step S201, the user enters a favorite design preference (preference) using the input device 21, whereby the preference selection unit 13 selects one piece of preference information from a plurality of pieces of preference information. Then, the process goes to step S202.

In step S202, the design output unit 14 outputs design information associated with the selected piece of preference information and evaluation information on this design information and displays them on the display device 22. Then, the process goes to step S203.

In step S203, the user enters a favorite design (i.e., clicks a “Select” button) using the input device 21, whereby the design selection determination unit 15 determines whether the user has selected the design information output to the display device 22. Here, if the user selects one piece of design information (YES), the process goes to S204, and if not (NO), the process goes to step S206.

In step S204, the design output unit 14 presents details of the selected design, and in step S205, registers evaluation information on the selected design in the evaluation registration unit 19. Step S205 may be performed after a vehicle is coated according to the selected design.

In step S206, the designer output unit 16 outputs designer information associated with the selected piece of preference information and evaluation information on the designer and the design to the display device 22 and displays them on the display device 22. Then, the process goes to step S207.

In step S207, the user enters a favorite designer (i.e., clicks a “Submit” button) using the input device 21, whereby the designer selection determination unit 17 determines whether the user has selected the designer information output to the display device 22. Here, if the user selects one piece of designer information (YES), the process goes to S208, and if not (NO), the process goes to step S210.

In step S208, the designer output unit 16 presents details of the selected designer and the design information created by the selected designer, and in step S209, registers evaluation information on the selected designer in the evaluation registration unit 19. Step S205 may be performed after a vehicle is coated according to the selected design.

In step S210, the design collection unit 18 transmits design collection information to the external server 90, and the process goes to step S211. In step S211, evaluation information on designs presented by other designers and on the other designers is registered in the evaluation registration unit 19 via the external server 90.

According to the present embodiment described above, the user can select, via the input device 21, the design information displayed on the display device 22 by the design output unit 14. Here, if the user has not selected the design information displayed on the display device 22, the design selection determination unit 15 determines that the user has not selected the design information displayed on the display device 22, and designer information registered by the designer output unit 16 is displayed on the display device 22. This allows the user to submit a request to create a design to a designer creating favorite designs based on the designer information.

If the user has not selected the designer information displayed on the display device 22, the designer selection determination unit 17 determines that the user has not selected the designer information displayed on the display device 22, and the design collection unit 18 can transmit design collection information to the external server 90. In particular, the design collection unit 18 can collect designs that fit the desired preference from the outside by associating the piece of preference information selected by the preference selection unit with the design collection information.

Although the embodiment of the present disclosure has been described in detail above, the present disclosure is not limited to the above embodiment, and various design changes are possible in so far as they are within the spirit of the present disclosure in the scope of the claims.

What is claimed is:

1. A vehicle design system that presents a coating design of a vehicle to a user, comprising a processing device,
wherein the processing device comprises:
a design registration unit configured to have registered therein a plurality of pieces of design information on the vehicle;
a designer registration unit configured to have registered therein designer information for each of a plurality of designers creating a design of the vehicle;
a design output unit configured to output design information registered in the design registration unit to a display device;
a design selection determination unit configured to determine whether the design information output to the display device has been selected by an input from an input device; and
a designer output unit configured to, if it is determined that the design information output to the display device has not been selected, output designer information registered in the designer registration unit to the display device.

2. The vehicle design system according to claim 1, wherein:
in the design registration unit, a plurality of pieces of design information is associated with and registered for each of a plurality of pieces of preference information,
the processing device comprises a preference selection unit configured to select one piece of preference information from the plurality of pieces of preference information by an input from the input device, and
the design output unit outputs design information associated with the selected piece of preference information to the display device.

3. The vehicle design system according to claim 1, wherein:
in the designer registration unit, a plurality of pieces of designer information is associated with and registered for each of a plurality of pieces of preference information,
the processing device comprises a preference selection unit configured to select one piece of preference information from the plurality of pieces of preference information by an input from the input device, and
the designer output unit outputs designer information associated with the selected piece of preference information to the display device.

4. The vehicle design system according to claim 1, further comprising:
a designer selection determination unit configured to determine whether the designer information output to the display device has been selected by an input from the input device; and
a design collection unit configured to transmit design collection information to an outside if it is determined that the designer information output to the display device has not been selected.

5. The vehicle design system according to claim 1, wherein the designer information includes design information created by the designer.

6. The vehicle design system according to claim 1, wherein the processing device further comprises an evaluation registration unit configured to have registered therein designer evaluation information for the designer by an input from the input device.

7. The vehicle design system according to claim 6, wherein:
the designer evaluation information includes design evaluation information for a design created by the designer, and
the designer output unit associates the design information created by the designer and the design evaluation information corresponding thereto with identification information on the designer as the designer evaluation information, and outputs the designer evaluation information to the display device.
